(19) United States
(12) Patent Application Publication
(10) Pub. No.: US 2010/0271175 A1
(43) Pub. Date: Oct. 28, 2010

(54) METHODS AND APPARATUSES FOR PROVIDING A PAGING PROCESS FOR MULTICARRIER

(75) Inventors: Chie-Ming Chou, Qingshui Town (TW); Chun-Yen Wang, Tainan City (TW)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Industrial Technology Research Institute

(21) Appl. No.: 12/729,744

(22) Filed: Mar. 23, 2010

Related U.S. Application Data
(60) Provisional application No. 61/172,460, filed on Apr. 24, 2009.

(51) Int. Cl. H04Q 1/30

(52) U.S. Cl. 340/7.25

(57) ABSTRACT

A method of providing a paging process for Multicarrier may include providing, from a communication node, multiple carriers over which a paging notification may be transmitted. The method may further include configuring the multiple carriers to provide support for paging of mobile devices based on a set of paging groups with which the communication node is associated. The configuring may include configuration of at least one carrier to provide support for less than all of the set of paging groups.

### CROSS REFERENCE TO RELATED APPLICATION

This application claims the benefit of U.S. Provisional Application No. 61/172,460, filed Apr. 24, 2009, the contents of which are incorporated herein in their entirety.

### TECHNOLOGICAL FIELD

Embodiments of the disclosure relate generally to communication technology and, more particularly, relate to an apparatus, method and a system for providing a paging process for Multicarrier.

### BACKGROUND

In order to provide easier or faster information transfer and convenience, telecommunication industry service providers are continually developing improvements to existing networks. While the demand for mobile broadband data services continues to grow, there may be a relative shortage of contiguous spectrum for deployment of access networks. Accordingly, it is expected that next generation broadband wireless access networks may be deployed using a combination of different spectrums. As next generation systems are deployed and the need for higher data rates continues to grow, the same technology may be deployed based on wider band radio frequency (RF) carriers, motivating a potential need to support a combination/concatenation of channel bandwidths to best fit the available spectrum while enabling data transmission over multiple component carriers. With the application of a scheme referred to as “Carrier Aggregation” or “Multicarrier”, networks may be enabled to operate over continuous or discontinuous carriers having different bandwidths. Thus, for example, a base station (BS) may be enabled to configure its control structure to improve system performance.

The Multicarrier scheme may utilize separate FFT and RF modules for each respective band that is used, and one (Medium Access Control) MAC entity may be employed to support Multicarrier functionalities. Based on user capabilities, network entities (e.g., a BS, a NodeB, an access point (AP), network device, network apparatus, repeater etc.) may be enabled to serve different users with corresponding different bandwidths. Since the BS is an example of a network entity, and for purposes of simplifying the description that follows, where the term “BS” is used hereafter, it should be understood to represent the network or an example of a generic network entity. Meanwhile, the term “MS” (mobile station) will be used to represent a device of a user (e.g., a mobile terminal or other user equipment (UE)). With the support of Multicarrier, a BS can flexibly use limited bandwidth to achieve high throughput and capacity to improve user experience at the MS.

In a conventional wireless cellular network, an MS may go into idle mode to save operating power if no connection is needed. When the MS goes into idle mode, the BS will give the MS paging operation parameters. The paging operation parameters may include the paging cycle, paging offset, paging group ID (PGID), paging MS identity and paging interval length parameters. The MS will then wake up periodically to hear the paging message from the BS in its paging cycle. The paging message may indicate specific actions to be taken by a particular MS. The actions may include keeping idle, waking up, updating system information, performing location update process, and/or the like.

When receiving an idle mode request, the BS may inform a paging controller that the MS is going into idle mode. The paging controller may then add the MS to a list of MSs associated with a particular PGID. When moving, a MS may move out the coverage of the BS providing it with service. In such a situation, the MS may not be able hear the paging message from its original BS and may therefore perform cell reselection to select a new preferred BS (e.g., a BS with the strongest received signal). The MS will start to synchronize with the preferred BS and be able to hear the paging information from the preferred BS in its control channel. The paging information may provide information indicative of a supporting PGID list in the preferred BS. If the MS finds the same PGID (i.e., the particular PGID with which it was previously associated) is also applicable to the preferred BS, the MS needs not take any action. However, if the particular PGID is not in the list of PGIDs supported by the preferred BS, the MS may perform a location update process (or the so-called tracking area update procedure). Accordingly, the MS will perform network re-entry to inform the preferred BS of the MS's entry. The preferred BS may then notify the paging controller that the MS is now camping on the preferred BS so that the paging controller can delete the MS from the paging list of the original paging group and add the MS to the paging list of the new paging group.

However, implementation of paging according to the scheme described above may be significantly complicated when a Multicarrier scheme is considered. Accordingly, it may be desirable to provide an improved paging process that may be employed successfully in connection with the Multicarrier scheme.

### BRIEF SUMMARY

A method, apparatus and computer program product are therefore provided that may enable the provision of a mechanism for providing a paging process for Multicarrier. In some embodiments, carriers may be configured to be fully or partially configured. As such, for example, a network entity such as the BS may be enabled to configure one or more carriers to enable broadcast of full or partial paging signaling. Thus, for example, fully configured and partially configured carriers may each have respective different downlink control structures based on characteristics of controls and data transmission.

In an exemplary embodiment, a method of providing a paging process for Multicarrier is provided. The method may include providing, from a communication node, multiple carriers over which a paging notification may be transmitted. The method may further include configuring the multiple carriers to provide support for paging of mobile devices based on a set of paging groups with which the communication node is associated. The configuring may include configuration of at least one carrier to provide support for less than all of the set of paging groups.

In another exemplary embodiment, an apparatus for providing a paging process for Multicarrier is provided. The apparatus may include a processing circuitry. The processing circuitry may be configured for providing, from a communication node, multiple carriers over which a paging notification may be transmitted. The processing circuitry may be further configured to enable the configuration of the multiple carriers to provide support for paging of mobile devices based on a set of paging groups with which the communication node is associated. The configuring of the multiple carriers may include configuration of at least one carrier to provide support for less than all of the set of paging groups.

In an exemplary embodiment, a method for providing a paging process for Multicarrier from the perspective of an electronic device of a user is provided. The method may include communicating, from a mobile device, with a communication node supporting multiple carriers over which a paging notification may be transmitted to the mobile device. The method may further include receiving an indication of paging group support associated with at least one of the carriers, and enabling selection of one of the carriers based on the selected carrier providing paging group support to enable the mobile device to receive paging notifications.

In an exemplary embodiment, an apparatus for providing a paging process for Multicarrier from the perspective of an electronic device of a user is provided. The apparatus may include processing circuitry configured for communicating, from a mobile device, with a communication node supporting multiple carriers over which a paging notification may be transmitted to the mobile device. The processing circuitry may further be configured for receiving an indication of paging group support associated with at least one of the carriers, and enabling selection of one of the carriers based on the selected carrier providing paging group support to enable the mobile device to receive paging notifications.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 illustrates a diagram of an example in which multiple fully configured carriers are provided as paging available carriers;

FIG. 2 illustrates a diagram of an example in which multiple fully configured carriers are provided including at least one fully configured paging unavailable carrier and at least one paging available carrier according to an exemplary embodiment of the disclosure;

FIG. 3 illustrates a diagram of an alternative embodiment in which a paging available carrier may only support paging notifications for some paging groups according to an exemplary embodiment of the disclosure;

FIG. 4 illustrates a block diagram of an apparatus for providing a paging process for Multicarrier according to an exemplary embodiment of the disclosure;

FIG. 5 illustrates a block diagram of a mobile station side apparatus for providing a paging process for Multicarrier according to an exemplary embodiment of the disclosure;

FIG. 6 is a flowchart according to an exemplary method for providing a paging process for Multicarrier according to an exemplary embodiment of the disclosure; and

FIG. 7 is a flowchart according to an alternative exemplary method for providing a paging process for Multicarrier according to an exemplary embodiment of the disclosure.

### DETAILED DESCRIPTION

Some embodiments of the disclosure will now be described more fully hereinafter with reference to the accompanying drawings, in which some, but not all embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout.

As indicated above, some embodiments of the disclosure may enable configuration of carriers to be fully or partially configured to enable broadcast of full or partial paging signaling. The fully configured and partially configured carriers may each have respective different downlink control structures based on characteristics of controls and data transmission. Accordingly, for example, some embodiments may define a paging procedure in which the paging carrier is configured in a network entity to enable the selection of a paging carrier when an idle mode MS migrates into a new cell or coverage area. Some embodiments may provide mechanism having relatively low overhead by which to facilitate user access to suitable carriers for receiving paging information in a Multicarrier environment.

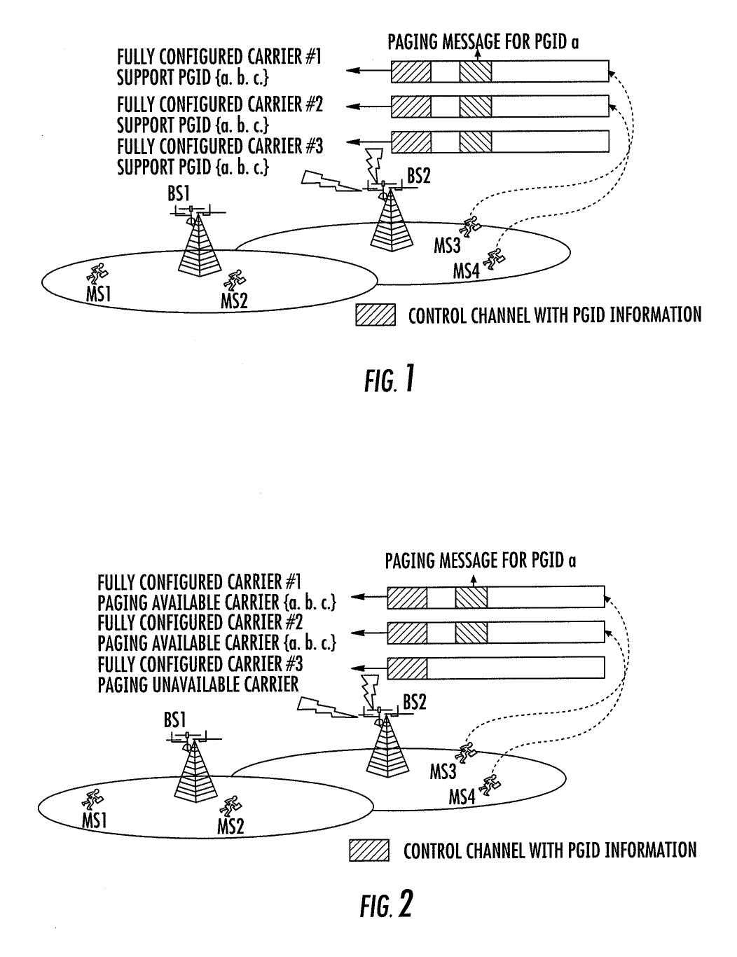

FIG. 1 illustrates an example of a network in which multiple BSs are providing coverage over adjacent cells in which paging may be accomplished. In the example of FIG. 1, two BSs are shown (BS1 and BS2) in communication with various MSs (BS1 with MS1 and MS2 while BS2 communicates with MS3 and MS4). As described above, each BS may support a corresponding list of PGIDs. According to example embodiments of the disclosure, a BS may be enabled to configured carriers to be fully or partially configured. In this example, three carriers are provided and each one is fully configured. As such, for example, each BS supports three PGIDs {a,b,c} via three fully configured carriers. A control channel (or superframe header (SFH)) of each respective carrier may provide PGID information for the BS and/or the corresponding carrier. Corresponding paging messages may be sent to designated MSs according to the paging offset and paging cycle.

If every fully configured carrier in a BS follows the unified idle mode parameters and provides identical paging notifications (including PGID information and paging messages), then the selection of a carrier for receiving paging notifications may be relatively simple for an MS. As such, when an MS moves into a coverage area of a different BS, the MS can arbitrarily pick one of the fully configured carriers among the available fully configured carriers and expected to receive the PGID information after successful cell reselection. If the MS is part of the same PGID supported by the BS covering the area into which the MS moved, then the MS can stay associated with the same carrier and wait for a corresponding paging message. Alternatively, if MS is not part of the PGID supported by the BS covering the area into which the MS moved, then the MS may perform a location update process at the currently camped carrier. Accordingly, no additional modification may be needed for idle mode support in Multicarrier. However, the provision of each fully configured carrier broadcast with identical PGID information paging messages creates some overlap that may be experienced as excess overhead.

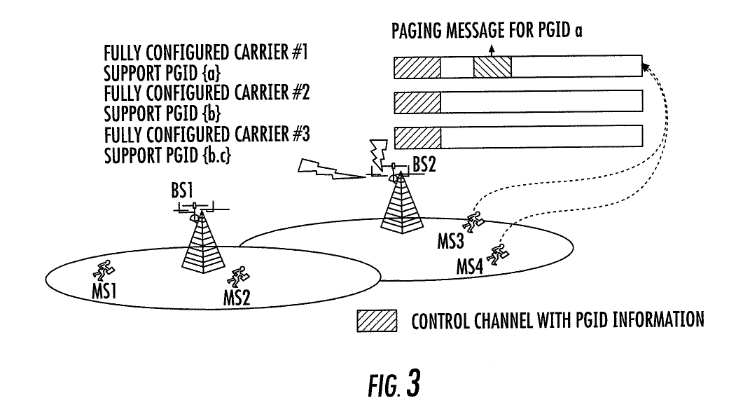

In order to reduce excess overhead, exemplary embodiments of the disclosure may provide alternative ways of providing idle mode support in Multicarrier. In an example embodiment, instead of all carriers being fully configured, a BS may be enabled to configure one or multiple component carriers to provide paging notification while other carriers may be configured to only provide partial support for paging messages. There are multiple ways by which to achieve this, an example of which is shown in FIG. 2.

FIG. 2 illustrates an example in which multiple component carriers are provided, but at least one component carrier is a “paging unavailable” carrier, while others are “paging available” carriers. As shown in FIG. 2, a BS may be enabled to select some component carriers as paging available carriers (e.g., carrier #1 and carrier #2). Paging available carriers may be configured to provide paging notification for all paging groups to which the corresponding BS belongs. Thus, for example, carrier #1 and carrier #2 each support PGIDs {a,b,c} and are configured to provide paging notifications for each supported PGID including paging group a. In some embodiments, a carrier may include an indicator to indicate that the carrier is a paging available carrier. The indicator may be one or more bits provided in the SFH or control channel.

Carriers that are not selected may then be designated as a paging unavailable carrier. A paging unavailable carrier is configured not to broadcast paging messages. As with the paging available carriers, an indictor may be used to indicate that a carrier is a paging unavailable carrier in some cases. The indictor may be, for example, an indication bit in a control channel, or may be provided by setting the support PGID list to none in the control channel. A paging unavailable carrier may provide the carrier information of at least one paging available carrier to enable a MS to find a paging available carrier. In other words, a fully configured paging unavailable carrier may provide carrier information to point a MS to a paging available carrier for that can provide paging messages for the MS.

In the example of FIG. 2, when a MS reselects a new carrier that is paging available, the MS may behave in similar fashion to the behavior described above in relation to a single-carrier case. When the MS reselects a new carrier that is paging unavailable, there may be two options: (1) if the paging unavailable carrier provides the information of at least one of paging available carrier, the MS may follow instructions and switch to the corresponding paging available carrier; or (2) if the carrier does not include any information about the paging available carrier, the MS may try to find another carrier which is paging available. During operation, the MS may initially automatically try to find another carrier that is paging available and then send a request to the BS. The BS may respond to the request with carrier information identifying at least one paging available carrier. For example, the MS may perform a location update process on the paging unavailable carrier, and the BS may respond at least one of paging carrier that supports the updated PGID and/or update the MS's PGID. In some cases, the MS may send a request to the BS, and the BS may re-configure the carrier to be a paging available carrier responsive to the request. Finally, the MS may camp on a paging available carrier with the assigned PGID.

In some examples, the BS may be enabled via the configuration provided according to an example embodiment of the disclosure to dynamically configure the paging available/unavailable carriers based on observations made by or reported to the BS. For example, if the frequency at which a BS receives location update requests from a paging unavailable carrier exceeds a threshold, the BS may re-configure the paging unavailable carrier to be a paging available carrier or additionally place information identifying at least one paging available carrier on the paging unavailable carrier to enable idle MSs to find a paging available carrier. Alternatively, if the frequency at which a BS receives location update requests from a paging available carrier is below a threshold, the BS may re-configure the corresponding carrier to be a paging unavailable carrier. In some situations, the BS may send an idle user detection message (e.g., a fake paging message to direct the MS to wake up) on a paging available carrier to determine whether there is any idle user camping on the corresponding carrier. If the BS detects that the time duration for which no idle MSs are camping on a particular paging available carrier exceeds a threshold, then the BS may re-configure the carrier to be a paging unavailable carrier.

FIG. 3 illustrates an alternative embodiment in which a paging available carrier may only support paging notifications for some paging groups. In the example of FIG. 3, component carriers (i.e., carrier #1, carrier #2, and carrier #3) are configured as paging available carriers. However, carrier #1 only supports PGID {a}, carrier #2 only supports PGID {b}, and carrier #3 only supports PGID {b,c}. Under this configuration, each carrier is configured to provide paging messages related to the particular PGIDs supported by the respective carriers. Thus, as currently configured, only carrier #1 supports paging messaging for PGID {a} and only carrier #3 supports paging messaging for PGID {c}. However, both carrier #2 and carrier #3 support paging messages for PGID {b}.

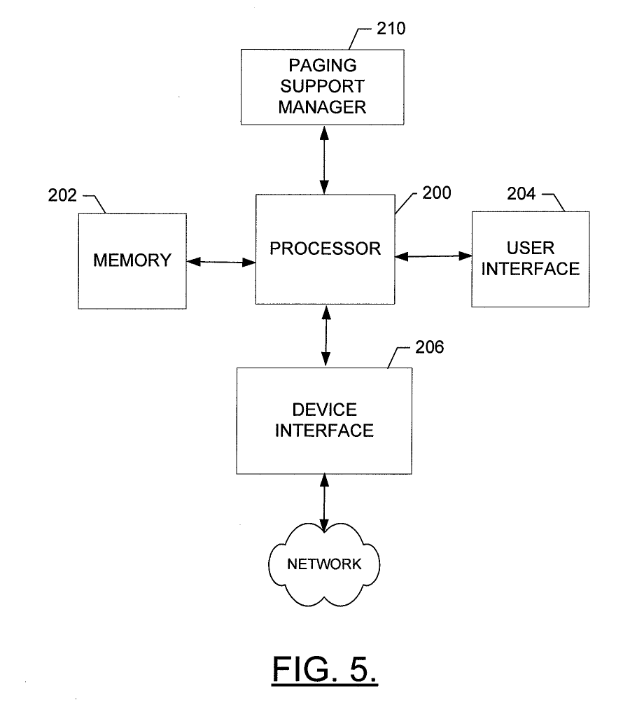

To provide paging information for an MS, a BS according to this example may have three possible ways to operate. In a first example, the BS may only provide paging information for those paging groups supported by each respective carrier. Thus, each carrier may broadcast its support PGID list (i.e., carrier #1 provides a list of (a), carrier #2 provides a list of {b} and carrier #3 provides a list of {b,c}). If a MS enters an area and finds that its paging group is not supported by a particular carrier employed in that area, then the MS may attempt to locate another carrier that supports the paging group of the MS. Alternatively, the MS may send a request to the BS. The request may include the PGID of the MS, and enable the BS to respond with information identifying another carrier, which may provide the paging notification for the paging group of the MS. In some cases, the BS may be enabled via the configuration provided according to an example embodiment of the disclosure to respond with a new PGID that is supported by the original and/or another carrier. The MS may be enabled via the configuration provided according to an example embodiment of the disclosure to reuse location update processes in some cases in order to make requests and receive responses. In an alternative example, the MS may include a timer (e.g., timer 220 of FIG. 5) having a value TLU. In such an example embodiment, the MS may initially attempt to find another carrier that supports its paging group during the timer run. However, when timer TLU expires, if no carrier supporting its paging group has yet been found, the MS may send a request to the BS as described above.

According to a second example BS operation scheme in accordance with this exemplary embodiment, the BS may provide paging information for those paging groups supported by each respective carrier, and also provide an indication of all PGIDs that are supported by the BS. In this example, each carrier may broadcast two PGID lists where one PGID list provides a list of PGIDs supported by the BS and the other provides a list of PGIDs supported by a particular carrier. As an example, carrier #1 provides a list of {a,b,c} and {a} to indicate that the corresponding BS supports PGIDs {a,b,c}, but the carrier supports PGID {a}. According to FIG. 3, carrier #2 provides a list of {a,b,c} and {b} to indicate that the corresponding BS supports PGIDs {a,b,c}, but the carrier supports PGID {b}. Carrier #3 provides a list of {a,b,c} and {b,c} to indicate that the corresponding BS supports PGIDs {a,b,c}, but the carrier supports PGIDs {b,c}.

A MS can first check whether its PGID be supported by this BS or not (i.e., if the MS is associated with PGID {b} or {c}, the MS may determine that the BS supports its PGID). If the MS determines that the BS does not support its PGID, the MS may perform a location update process through the currently camped carrier and/or another carrier. If, on the other hand, the BS supports the PGID of the MS, the MS may determine whether a particular carrier supports the PGID of the MS. Thus, for example, if the carrier supports the PGID of the MS, the MS may stay with the carrier and expect to receive paging messages. However, if the carrier does not support the PGID of the MS, the MS may know (based on the BS supporting the PGID) that another carrier of this BS will support the PGID of the MS. As a result, the MS may try to find another carrier of the BS that supports its paging group.

Alternatively, the MS may send a request including the PGID of the MS, and the BS may respond to the request with information identifying another carrier that may provide the paging notification for the paging group identified by the PGID of the MS or the BS may reconfigure the carrier to support the PGID of the MS. The MS may be enabled to reuse location update processes in some cases in order to facilitate the making of requests and reception of responses. In an alternative example similar to the alternative described above, the MS may include a timer having a value TLU. In such an example embodiment, the MS may initially attempt to find another carrier that supports its paging group during the timer run. However, when timer TLU expires, if no carrier has yet been found, the MS may send a request to the BS as described above.

According to a third example BS operation scheme in accordance with the exemplary embodiment of FIG. 3, the BS may provide the paging information for those paging groups supported by a particular carrier and the BS may also provide the information of another carrier, which support other paging groups. In this example, each carrier may be configured to broadcast a complete PGID support list for the BS. For example, according to the scenario of FIG. 3, carriers #1, #2, and #3 may each provide the information of {a on #1, b on #2 #3, and c on #3}. If the MS does not find that its PGID is supported the listing for all the carriers in this BS, then the MS may perform a location update process and/or acquire a new PGID that may be supported by this BS. If the MS finds that its paging group is not supported by the carrier with which the MS is currently associated, but that the paging group of the MS is supported by this BS (i.e., by another carrier of this BS), then the MS may attempt to switch to a carrier of this BS that does support its PGID based on the information provided regarding the carriers.

In some embodiments, the options available to an MS that discovers that its PGID is not supported by the current carrier may be provided in a hierarchy. In this regard, for example, an MS may initially try itself to find another, perhaps by turning on all RF modules of the MS in order to see if any other carriers support the MS's PGID. If that does not work, the MS may send a request including the PGID of the MS to the BS to enable the BS to respond. The BS may respond with information identifying another carrier, which may provide the paging notification for the PGID of the MS or the BS may reconfigure the carrier to support the PGID of the MS. A next option may include the performance of a location update procedure by the MS, in response to which the BS may assign the MS to another PGID (e.g., a supported PGID) or identify another carrier that supports the PGID of the MS. In some cases, the MS may then attempt to switch to the identified carrier while running the timer described above and then initiate sending a request to the BS if the timer expires.

There are yet further alternatives to the embodiments described above in connection with FIGS. 2 and 3. For example, in another alternative embodiment, when assigning a PGID for a particular MS, the BS may be configured to provide two logical IDs as identifiers for paging support. One logical ID, which may be called a primary PGID, may represent information descriptive of the BS and the other logical ID, which may be called a secondary PGID, may represent information descriptive of the carrier. All carriers associated with a particular BS may be configured to have the same primary PGID. However, each individual carrier associated with the particular BS may be enabled to have different individual secondary PGIDs.

An MS may reference the primary and secondary PGIDs associated with a particular BS to determine whether the PGID of the MS is supported by any carrier associated with the BS. For example, if a MS finds that its secondary PGID is not supported by a particular carrier currently being employed, but the primary PGID indicates support, the MS may determine that it can switch to a different carrier for support from this BS. Accordingly, the MS may attempt to camp on the carrier that supports the secondary PGID of the MS. Alternatively, the MS may send a request including the secondary PGID of the MS to enable the BS to respond with information identifying another carrier, which may provide paging notification services for the secondary PGID of the MS. As indicated above, the MS may be enabled via the configuration provided according to an example embodiment of the disclosure to reuse location updates in some cases in order to facilitate the making of requests and reception of responses. In an alternative example similar to the alternative described above, the MS may include a timer having a value TLU. In such an example embodiment, the MS may initially attempt to find another carrier that supports its paging group during the timer run. However, when timer TLU expires, if no carrier has yet been found, the MS may send a request to the BS as described above. In implementation, the two logical IDs described above may be provided as two different physical IDs (i.e., as a primary PGID and a separate secondary PGID). However, in some cases the two different physical IDs may be combined into a single composite ID that may perhaps include a symmetric structure. As an example, an eight bit PGID may include a primary field defined by the first four or most significant bits (MSBs) and a secondary field defined by the last four or least significant bits (LSBs).

In some embodiments, the various example embodiments described above may be combined in various ways to create other composite embodiments. For example, a BS may be provided with any combination of paging unavailable carriers, paging available carriers and partial paging carriers. Moreover, based on the given paging information in each carrier, a MS may be enabled to determine the carrier that supports the paging group associated with the MS or perform a location update process to have the information identifying another carrier and/or a new PGID assigned.

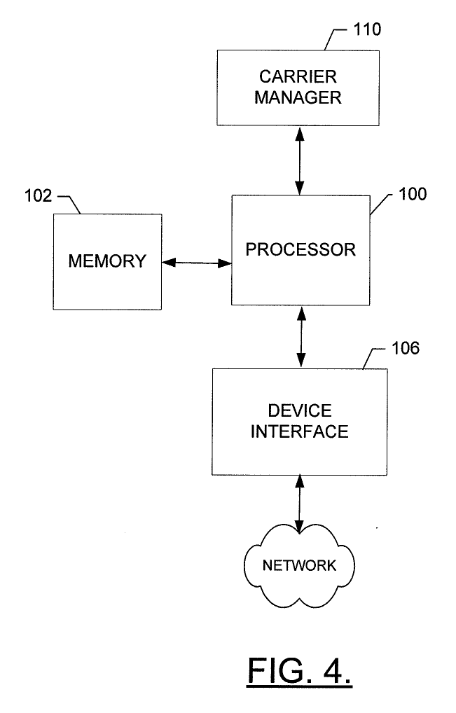

In an exemplary embodiment, an apparatus within the BS may be configured to perform functions associated with managing or controlling several of the operations described above. FIG. 4 illustrates an example of an apparatus for providing a paging process for Multicarrier. In this regard, the apparatus may include or otherwise be in communication with a processor 100, a memory 102, and a device interface 106. The memory 102 may include, for example, volatile and/or non-volatile memory. The memory 102 may be a computer-readable storage medium. The memory 102 may be distributed. That is, portions of memory 102 may be removable or non-removable. In some embodiments, memory 102 may be implemented in a network (not shown) coupled to communicate with BS. The memory 102 may be configured to store information, data, applications, instructions or the like for enabling the apparatus to carry out various functions in accordance with exemplary embodiments of the disclosure. For example, the memory 102 could be configured to buffer input data for processing by the processor 100 and/or store instructions for execution by the processor 100.

The processor 100 may be embodied in a number of different ways. For example, the processor 100 may be embodied as various processing means such as processing circuitry embodied as a coprocessor, a controller or various other processing devices including integrated circuits such as, for example, an ASIC (application specific integrated circuit), embedded processor, an FPGA (field programmable gate array), a hardware accelerator, a microcontroller, or the like. In an exemplary embodiment, the processor 100 may be configured to execute data or instructions stored in the memory 102 or otherwise accessible to the processor 100. For example, processor 100 may contain code operable to maintain and transmit information stored in a buffer associated with memory 102. In other embodiments, processor 100 can exchange data, including control information and instructions with other devices or functional modules coupled to any one of BS.

Meanwhile, the device interface 106 may be any means such as a device or circuitry embodied in either hardware, software, or a combination of hardware and software that is configured to receive and/or transmit data from/to a network and/or any other device or module in communication with the apparatus. In this regard, the device interface 106 may include, for example, an antenna (or multiple antennas) and supporting hardware and/or software to encode/decode, modulate/demodulate, and to perform other wireless communication channel-related functions for enabling communications with a wireless communication network. In fixed environments, the device interface 106 may alternatively or also support wired communication. As such, the device interface 106 may include a communication modem and/or other hardware/software for supporting communication via cable, digital subscriber line (DSL), universal serial bus (USB), Ethernet, FireWire®, or other mechanisms.

In an exemplary embodiment, the processor 100 may be embodied as, include or otherwise control a carrier manager 110. The carrier manager 110 may be any means such as a device or circuitry embodied in hardware, software or a combination of hardware and software (e.g., processor 100 operating under software control) that is configured to perform the corresponding functions of the carrier manager 110, as described below.

In an exemplary embodiment, the carrier manager 110 may operate responsive to execution of instructions, code, modules, applications and/or circuitry for configuring carriers (e.g., specific bands of spectrum comprising communication resources available to a BS for use) to support paging in a Multicarrier environment. From the perspective of a paging controller that interfaces with multiple BSs for paging operations, selected ones of the multiple BSs may be grouped together as paging groups identified by PGIDs. Thus, for MS mobility, if the MS moves from one BS to another BS and the other BS (i.e., the new BS) is in the same PGID as the one BS (i.e., the old BS), then the MS can still receive paging messages without further action in the new BS. However, if the MS moves to the new BS and the new BS is not associated with the PGID of the old BS, the MS will need to act to continue to receive paging messages. The carrier manager 110 may be used by the BS to configure carriers to provide a structure and environment for enabling the MS to more easily locate a carrier that may support it for paging purposes.

In a typical example, a BS may be configured to send at least two messages that support paging operations. A system information message may provide PGID information and may be broadcast periodically. Meanwhile, a paging message may be sent to wake up an idle user, for example, in response to an attempt by another party to call the user. The carrier manager 110 may be configured to enable the BS to configure carriers associated with the BS to provide paging notifications to MSs associated therewith (i.e., camped in the coverage area of the BS). However, the carrier manager 110 may be configured to provide configuration of paging unavailable carriers, paging available carriers and partial paging carriers. Thus, unlike conventional paging mechanisms that essentially only provide what would be considered fully configured paging available carriers, embodiments of the disclosure support Multicarrier environments with improved flexibility.

In an exemplary embodiment, an apparatus within the MS may be configured to perform functions associated with managing or controlling several of the operations of the MS as they relate to the operations described above. FIG. 5 illustrates an example of an apparatus for utilizing a paging process in a Multicarrier environment. In this regard, the apparatus may include or otherwise be in communication with a processor 200, a memory 202, and a device interface 206. The processor 200, the memory 202 and the device interface 206 may be similar in structure to the processor 100, memory 102 and device interface 106 described above and thus the specific details regarding these components will not be repeated.

In an example embodiment, the apparatus of FIG. 5 may further include a user interface 204. The user interface 204 may be in communication with the processor 200 to receive an indication of a user input at the user interface 204 and/or to provide an audible, visual, mechanical or other output to the user. As such, the user interface 204 may include, for example, a keyboard, a mouse, a joystick, a display, a touch screen, soft keys, a microphone, a speaker, or other input/output mechanisms.

In an exemplary embodiment, the processor 200 may be embodied as, include or otherwise control a paging support manager 210. The paging support manager 210 may be any means such as a device or circuitry embodied in hardware, software or a combination of hardware and software (e.g., processor 200 operating under software control) that is configured to perform the corresponding functions of the paging support manager 210, as described below.

In an exemplary embodiment, the paging support manager 210 may operate responsive to execution of instructions, code, modules, applications and/or circuitry for determining whether the MS has paging support via a specific carrier and/or select a carrier to provide the MS with paging support. As such, the paging support manager 210 may be configured to determine whether carriers associated with a particular BS support the paging group of the MS. The paging support manager 210 may also be configured to enable selection of a preferred carrier.

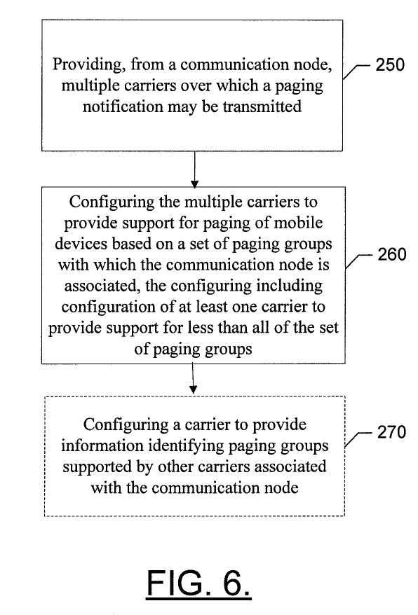

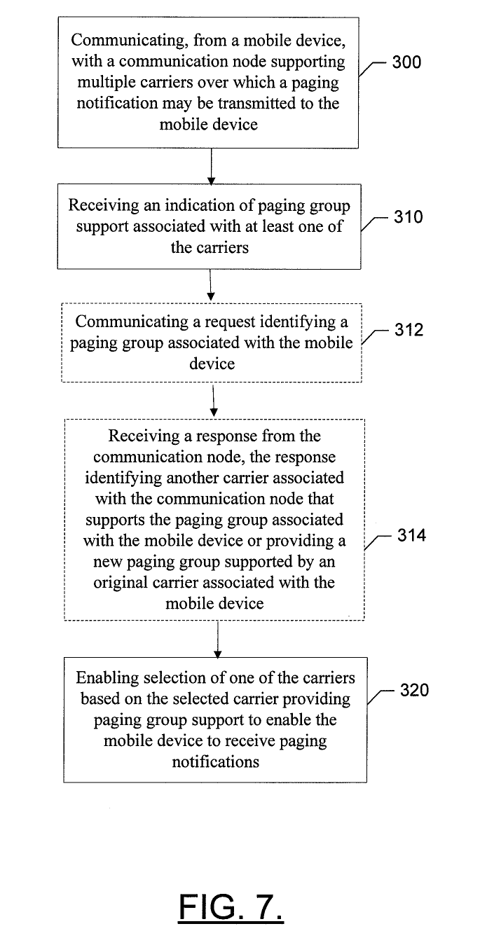

FIGS. 6 and 7 are flowcharts of a system, method and program product according to exemplary embodiments of the invention. It will be understood that each block of the flowcharts, and combinations of blocks in the flowcharts, can be implemented by various means, such as hardware, firmware, and/or software including one or more computer program instructions. For example, one or more of the procedures described above may be embodied by computer program instructions. In this regard, the computer program instructions which embody the procedures described above may be stored by a memory and executed by a processor. As will be appreciated, any such computer program instructions may be loaded onto a computer or other programmable apparatus (i.e., hardware) to produce a machine, such that the instructions which execute on the computer or other programmable apparatus create means for implementing the functions specified in the flowchart block(s). These computer program instructions may also be stored in a computer-readable electronic storage memory that can direct a computer or other programmable apparatus to function in a particular manner, such that the instructions stored in the computer-readable memory produce an article of manufacture including instruction means which implement the function specified in the flowchart block(s). The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowcharts block(s).

Accordingly, blocks of the flowchart support combinations of means for performing the specified functions, combinations of steps for performing the specified functions and program instruction means for performing the specified functions. It will also be understood that one or more blocks of the flowchart, and combinations of blocks in the flowchart, can be implemented by special purpose hardware-based computer systems which perform the specified functions or steps, or combinations of special purpose hardware and computer instructions.

In this regard, one embodiment of a method for providing a paging process for Multicarrier from the network side perspective as provided in FIG. 6 may include providing, from a communication node, multiple carriers over which a paging notification may be transmitted at operation 250. The method may further include configuring the multiple carriers to provide support for paging of mobile devices based on a set of paging groups with which the communication node is associated at operation 260. The configuring may include configuration of at least one carrier to provide support for less than all of the set of paging groups.

In some embodiments, the method may include further optional operations, an example of which is shown in dashed lines in FIG. 6. Optional operations may be performed in any order and/or in combination with each other in various alternative embodiments. As such, the method may further include configuring a carrier to provide information identifying paging groups supported by other carriers associated with the communication node at operation 270.

In some embodiments, certain ones of the operations above may be modified or further amplified as described below. It should be appreciated that each of the modifications or amplifications below may be included with the operations above either alone or in combination with any others among the features described herein. In this regard, for example, configuring the multiple carriers may include configuring a carrier to provide an indication of paging groups supported by the carrier, configuring a carrier to provide an indication of paging groups supported by the communication node and/or configuring at least one carrier to provide no paging notifications. In some embodiments, configuring the multiple carriers may include dynamically configuring a carrier to change paging group support information based on operation of a timer or based on observation of support activity relative to a threshold.

In an exemplary embodiment, an apparatus for performing the method of FIG. 6 above may comprise a processor (e.g., the processor 100) configured to perform some or each of the operations (250-270) described above. The processor may, for example, be configured to perform the operations (250-270) by performing hardware implemented logical functions, executing stored instructions, or executing algorithms for performing each of the operations.

In another exemplary embodiment, a method for providing a paging process for Multicarrier from the perspective of an electronic device of a user is provided. The method may include communicating, from a mobile device, with a communication node supporting multiple carriers over which a paging notification may be transmitted to the mobile device at operation 300. The method may further include receiving an indication of paging group support associated with at least one of the carriers at operation 310, and enabling selection of one of the carriers based on the selected carrier providing paging group support to enable the mobile device to receive paging notifications at operation 320.

In some embodiments, the method may include further optional operations, an example of which is shown in dashed lines in FIG. 7. Optional operations may be performed in any order and/or in combination with each other in various alternative embodiments. As such, the method may further include communicating a request identifying a paging group associated with the mobile device at operation 312, and receiving a response from the communication node at operation 314. The response may identify another carrier associated with the communication node that supports the paging group associated with the mobile device or provide a new paging group supported by an original and/or another carrier associated with the mobile device.

In some embodiments, certain ones of the operations above may be modified or further amplified as described below. It should be appreciated that each of the modifications or amplifications below may be included with the operations above either alone or in combination with any others among the features described herein. In this regard, for example, receiving the indication may include receiving information indicating that a paging group associated with the mobile device is not supported by a currently employed carrier. In some cases, the mobile device may include a timer. The mobile device may be configured to attempt to locate a carrier based on the indication after expiry of the timer.

In an exemplary embodiment, an apparatus for performing the method of FIG. 7 above may comprise a processor (e.g., the processor 200) configured to perform some or each of the operations (300-320) described above. The processor may, for example, be configured to perform the operations (300-320) by performing hardware implemented logical functions, executing stored instructions, or executing algorithms for performing each of the operations.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A method comprising:
providing, from a communication node, multiple carriers over which a paging notification may be transmitted; and
configuring the multiple carriers to provide support for paging of mobile devices based on a set of paging groups with which the communication node is associated, the configuring including configuration of at least one carrier to provide support for less than all of the set of paging groups.

2. The method of claim 1, wherein configuring the multiple carriers comprises configuring a carrier to provide an indication of paging groups supported by the carrier.

3. The method of claim 1, further comprising configuring the multiple carriers comprises configuring a carrier to optionally provide an indication of paging groups supported by the communication node.

4. The method of claim 1, further comprising configuring a carrier to optionally provide information identifying paging groups supported by other carriers associated with the communication node.

5. The method of claim 1, wherein configuring the multiple carriers comprises configuring a carrier to provide no paging notifications.

6. The method of claim 5, wherein configuring the carrier to provide no paging notifications comprises configuring the carrier based on using an additional indicator, or appending no paging notifications, or setting a number of paging group support associated with the carrier to zero.

7. The method of claim 1, wherein configuring the multiple carriers comprises dynamically configuring a carrier to change paging group support information.

8. The method of claim 7, wherein dynamically configuring the carrier comprises dynamically configuring the carrier to change a paging group based on operation of a timer or based on observation of support activity relative to a threshold.

9. An apparatus comprising processing circuitry configured to:
provide, from a communication node, multiple carriers over which a paging notification may be transmitted; and
configure the multiple carriers to provide support for paging of mobile devices based on a set of paging groups with which the communication node is associated, the configuration including configuring at least one carrier to provide support for less than all of the set of paging groups.

10. The apparatus of claim 9, wherein the processing circuitry is configured to configure the multiple carriers by configuring a carrier to provide an indication of paging groups supported by the carrier.

11. The apparatus of claim 9, further comprising the processing circuitry being configured to configure the multiple carriers by configuring a carrier to optionally provide an indication of paging groups supported by the communication node.

12. The apparatus of claim 9, further comprising the processing circuitry being configured to enable configuration of a carrier to optionally provide information identifying paging groups supported by other carriers associated with the communication node.

13. The apparatus of claim 9, wherein the processing circuitry is configured to configure the multiple carriers by configuring a carrier to provide no paging notifications.

14. The apparatus of claim 13, wherein the processing circuitry is configured to configure the carrier to provide no paging notifications based on using an additional indicator, or appending no paging notifications, or setting a number of paging group support associated with the carrier to zero.

15. The apparatus of claim 9, wherein the processing circuitry is configured to configure the multiple carriers by dynamically configuring a carrier to change paging group support information.

16. The apparatus of claim 15, wherein the processing circuitry is configured to dynamically configure the carrier to change a paging group based on operation of a timer or based on observation of support activity relative to a threshold.

17. A method comprising:
communicating, from a mobile device, with a communication node supporting multiple carriers over which a paging notification may be transmitted to the mobile device;
receiving an indication of paging group support associated with at least one of the carriers; and
enabling selection of one of the carriers based on the carrier providing paging group support to enable the mobile device to receive paging notifications.

18. The method of claim 17, wherein receiving the indication comprises receiving information indicating that a paging group associated with the mobile device is not supported by a current carrier.

19. The method of claim 17, further comprising:
communicating a request identifying a paging group associated with the mobile device; and
receiving a response from the communication node, the response identifying another carrier associated with the communication node that supports the paging group associated with the mobile device or providing a new paging group supported by an original carrier or another carrier associated with the mobile device.

20. The method of claim 19, wherein the mobile device includes a timer, and wherein the mobile device is configured to attempt to communicate with a communication node and receive a response including an indication to locate a carrier providing paging group support associated with the mobile device after expiry of the timer.

21. An apparatus comprising processing circuitry configured to:
communicate, from a mobile device, with a communication node supporting multiple carriers over which a paging notification may be transmitted to the mobile device;
receive an indication of paging group support associated with at least one of the carriers; and
enable selection of one of the carriers based on the carrier providing paging group support to enable the mobile device to receive paging notifications.

22. The apparatus of claim 21, wherein the processing circuitry is configured to receive the indication by receiving information indicating that a paging group associated with the mobile device is not supported by a current carrier.

23. The apparatus of claim 21, wherein the processing circuitry is further configured to:
communicate a request identifying a paging group associated with the mobile device; and
receive a response from the communication node, the response identifying another carrier associated with the communication node that supports the paging group associated with the mobile device or providing a new paging group supported by an original carrier or another carrier associated with the mobile device.

24. The apparatus of claim 23, wherein the mobile device includes a timer, and wherein the apparatus is configured to attempt to communicate with a communication node and receive a response including an indication to locate a carrier providing paging group support associated with the mobile device after expiry of the timer.
